(19) United States
(12) Patent Application Publication
(10) Pub. No.: US 2002/0073532 A1
(43) Pub. Date: Jun. 20, 2002

(54) Method and apparatus for contouring motor brushes

(76) Inventor: Harald E. Blaettner, Fort Wayne, IN (US)

Correspondence Address: John S. Beulick, Armstrong Teasdale LLP, One Metropolitan Square, Suite 2600, St. Louis, MO, 63102, US

(21) Appl. No.: 09/737,623

(22) Filed: Dec. 15, 2000

(51) Int. Cl. H01R 43/06; H01R 43/10

(52) U.S. Cl. 29/597

(57) ABSTRACT

A method of contouring a motor brush includes mounting a brush in a brush card and contouring the brush. The brushes are retracted and a contour wheel is placed proximate the brushes such that when the brushes are released, the brushes contact the contour wheel. The contour wheel includes an abrasive surface and when rotated the wheel wears-in the brushes. Accordingly, the brushes are worn-in to a commutator before the commutator is installed in the motor. Upon initial motor run, the contoured brushes allow the motor to run quieter than a motor without contoured brushes.

### BACKGROUND OF THE INVENTION

This invention relates generally to dynamoelectric machines and, more particularly, to brush commutated direct current (DC) motors.

Brush commutated motors typically include a motor housing, a rotor assembly, a stator including one or more field windings or one or more permanent magnets. The rotor assembly includes a rotor core and a rotor shaft extending through the rotor core. The rotor core includes a plurality of armature windings attached to a commutator mounted to the rotor shaft. The commutator includes a plurality of commutator segments or bars extending radially out from the shaft and electrically insulated from each other by a plurality of insulators.

The motor housing includes at least one endshield and houses at least a portion of the rotor assembly. Electric motors also typically include at least one bearing sized to receive and support the rotor shaft, and at least one inner bearing cap separated from the bearing. Typically, the bearing is positioned between an endshield and an inner bearing cap and facilitates rotation of the rotor shaft when the field windings are energized. A yoke or brush card including a plurality of brushes is mounted within the housing such that the brushes make slideable contact with the commutator. In a motor having field windings, the field windings are energized producing a plurality of fixed stator poles. In a permanent magnet motor, the permanent magnets produce a plurality of fixed stator poles.

In both permanent magnet motors and motors with field windings, the brushes and commutator are positioned such that the current flow through the armature windings generates a plurality of magnetic rotor poles that oppose the fixed stator poles causing the shaft to rotate. The commutator bars are arranged to alternate the current direction through the armature windings such that, while the armature windings physically rotate, the magnetic poles produced by the armature windings are substantially stationary. Accordingly, a torque is continuously provided.

Typically, the brushes of a motor are generally shaped or contoured to the shape of the commutator. The brushes are less expensive to repair and replace than the commutator and, accordingly, the brushes are manufactured “softer” than the commutator such that the brushes wear more than the commutator does. As the brushes wear-in, the brushes become contoured to the shape of the commutator and the motor runs quieter than the motor ran initially. Additionally, a motor with brushes that have worn-in or seated to the commutator is beneficial because the initial non-symmetric brush commutator contact of a new motor can reduce performance, lead to thermal overload, and cause application deficiency.

Motor manufacturers have employed several methods to wear-in the brushes. One method is to run a new motor at a no-load condition for an extended period of time which extends the manufacturing time and raises manufacturing costs. Another method is to apply an abrasive material such as a seating stone between the brushes and the commutator. The material causes the brushes to wear-in quicker but raises manufacturing costs because the material must be applied and then removed from the commutator and the brushes after the brushes have worn-in to the commutator. Additionally, utilizing an abrasive material at the commutator-brush interface can lead to bearing contamination that can shorten the operating life of a motor.

### BRIEF SUMMARY OF THE INVENTION

A method of contouring a motor brush includes mounting a brush in a brush card and mounting the brush card to at least one of a stator and an endshield. The brushes are retracted and a contour wheel is placed proximate the brushes such that when the brushes are released, the brushes contact the contour wheel. The contour wheel includes an abrasive surface and a handle to facilitate a rotation of the wheel. The wheel is rotated one-half turn in a first direction and one-half turn in a second direction. The brushes are retracted and the contour wheel is replaced with a commutator sized approximately equal to the contour wheel. Accordingly, the brushes are worn-in to the commutator before the commutator is installed in the motor. Upon initial motor run, a motor with contoured brushes runs quieter than a motor without contoured brushes.

Apparatus for contouring a brush for a motor includes a contour wheel including an abrasive surface and a shaft extending substantially perpendicular to the contour wheel. A top plate is attached to the shaft opposite the wheel and away from an end of the shaft such that the shaft extends through the top plate. The top plate can be engaged with at least one of a stator and an endshield. The top plate includes at least one bearing to rotatably support the shaft.

### BRIEF DESCRIPTION OF THE DRAWINGS

FIG. 1 is top view, with parts cut away, of one embodiment of a contour apparatus;

FIG. 2 is a top view, with parts cut away, of an alternative embodiment of a contour apparatus; and

FIG. 3 is a cross sectional view of a motor.

### DETAILED DESCRIPTION OF THE INVENTION

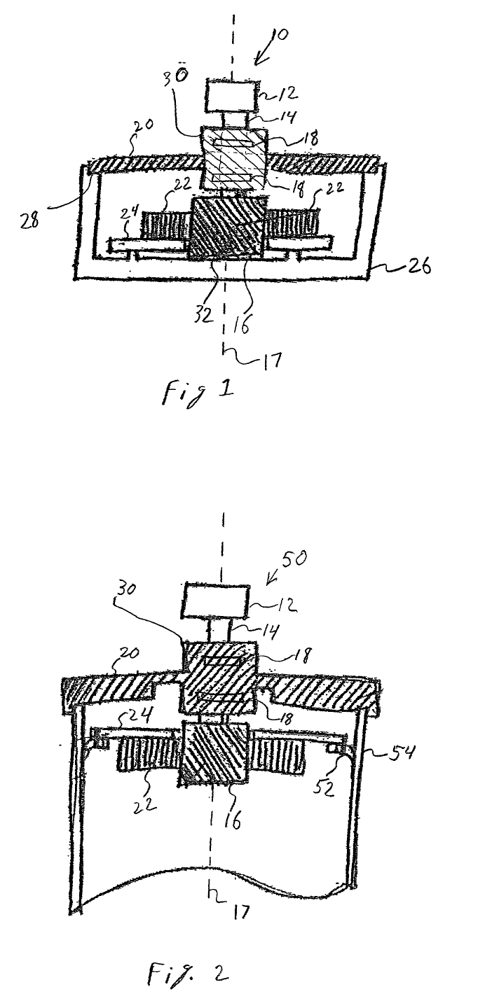

FIG. 1 is a top view, with parts cut away, of one embodiment of a contour apparatus 10 including a handle 12 and a shaft 14 extending from handle 12 to a contour wheel 16 including an axis 17. Contour apparatus 10 further includes at least one bearing 18 and a top plate 20 extending substantially perpendicular to axis 17 such that axis 17 is substantially centered in top plate 20. Shaft 14 extends through top plate 20 and is rotatably supported by bearing 18. In an exemplary embodiment, contour apparatus 10 includes a plurality of bearings 18 to provide a proper wheel alignment of contour wheel 16 with a plurality of brushes 22 attached to a brush card 24. Brushes 22 can be positioned in a normal position and a retracted position. Brushes 22 are resiliently mounted to brush card 24 such that a plurality of brush springs (not shown) bias brushes 22 toward their normal position.

Brush card 24 is attached to an endshield 26 of a motor (not shown in FIG. 1). Endshield 26 includes a rabbet 28 to which a housing body (not shown in FIG. 1) is attached to fabricate the motor. Top plate 20 includes a bearing portion 30 that houses bearings 18. Bearing portion 30 is substantially centered on top plate 20 and top plate 20 is sized to fit within rabbet 28 such that shaft 14 is substantially centered between brushes 22. Contour wheel 16 is substantially circular and is sized approximately equal in radius to a commutator (not shown in FIG. 1) of the motor. Contour wheel 16 includes an abrasive surface 32. In an exemplary embodiment, abrasive surface 32 has a grit size of 320 or less using the CAMI (Coated Abrasives Manufacturer's Institute) standard. In an alternative embodiment, abrasive surface 32 has a grit size of 240 or less.

Contour apparatus 10 is utilized by retracting brushes 22 and positioning top plate 20 within rabbet 28 such that contour wheel 16 is proximate to brushes 22 and will contact brushes 22 when brushes 22 are released from their retracted position. Since brushes 22 are resiliently mounted, brushes 22 are biased toward their normal positions when released from their retracted positions. After brushes 22 are released from their retracted position, handle 12 is rotated causing contour wheel 16 to rotate against brushes 22. Since contour wheel 16 includes an abrasive surface 32, brushes 22 wear-in to contour wheel 16. Additionally, since contour wheel 16 is sized approximately equal to the commutator, brushes 22 wear-in to the commutator prior to the commutator being mounted in the motor.

In an exemplary embodiment, handle 12 and contour wheel 16 are rotated one-half turn in one direction, such as, for example, clockwise, and one-half turn in a second direction, such as, for example, counter-clockwise, such that brushes 22 wear-in from rotatably contacting abrasive surface 32 in both directions. Brushes 22 are retracted and contour apparatus 10 is removed to facilitate further fabrication of the motor. Accordingly, brushes 22 are contoured while in their assembled locations and initial motor noise is reduced. After contouring a plurality of brushes, a dust may form on abrasive surface 32 that is removed by releasing compressed air proximate to abrasive surface 32 such that the dust is blown from abrasive surface 32. Alternatively, a vacuum (not shown) is utilized to remove the dust from abrasive surface 32.

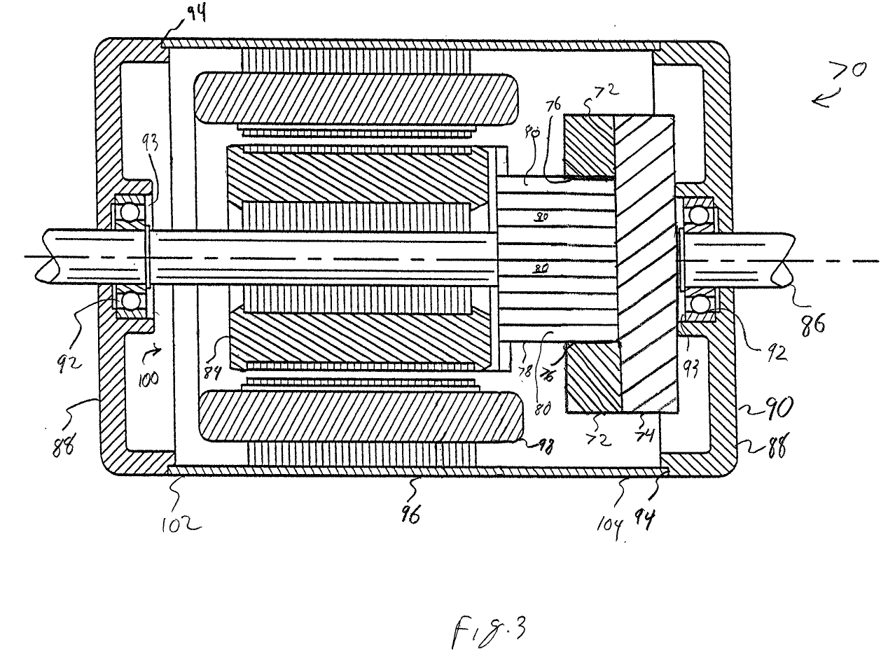

FIG. 2 is a top view, with parts cut away, of an alternative embodiment of a contour apparatus 50. Contour apparatus 50 is substantially similar to contour apparatus 10 shown in FIG. 1, and components in contour apparatus 50 that are identical to components in contour apparatus 10 are identified in FIG. 2 using the same reference numerals used in FIG. 1. Accordingly, contour apparatus 50 includes a handle 12 and a shaft 14 extending from handle 12 to a contour wheel 16 including an axis 17. Contour apparatus 50 further includes at least one bearing 18 and a top plate 20 extending substantially perpendicular to axis 17 such that axis 17 is substantially centered in top plate 20. Shaft 14 extends through top plate 20 and is rotatably supported by bearing 18. In an exemplary embodiment, contour apparatus 50 includes a plurality of bearings 18 to provide a proper wheel alignment of contour wheel 16 with a plurality of brushes 22 attached to a brush card 24. Brushes 22 can be positioned in a normal position and a retracted position. A plurality of brush springs (not shown) bias brushes 22 in their normal position.

Brush card 24 is attached to a retaining tab 52 mounted in a stator housing 54. Top plate 20 includes a bearing portion 30 that houses bearings 18. Bearing portion 30 is substantially centered on top plate 20 and top plate 20 is sized to fit around housing 54 such that shaft 14 is substantially centered between brushes 22. Contour wheel 16 is substantially circular and is sized approximately equal in radius to a commutator (not shown). Contour wheel 16 includes an abrasive surface 32. In an exemplary embodiment, abrasive surface 32 has a grit size of 320 or less using the CAMI (Coated Abrasives Manufacturer's Institute) standard. In an alternative embodiment, abrasive surface 32 has a grit size of 240 or less.

Contour apparatus 50 is utilized by retracting brushes 22 and positioning top plate 20 around housing 54 such that contour wheel 16 is proximate to brushes 22 and will contact brushes 22 when brushes 22 are released from their retracted position and biased toward their normal position. After brushes 22 are released from their retracted position, handle 12 is rotated causing contour wheel 16 to rotate against brushes 22. Since contour wheel 16 includes an abrasive surface 32, brushes 22 wear-in to contour wheel 16. Additionally, since contour wheel 16 is sized approximately equal to the commutator, brushes 22 wear-in to the commutator prior to the commutator being mounted in the motor.

In an exemplary embodiment, handle 12 and contour wheel 16 are rotated one-half turn in one direction, such as, for example, clockwise, and one-half turn in a second direction, such as, for example, counter-clockwise, such that brushes 22 wear-in from rotatably contacting abrasive surface 32 in both directions. Brushes 22 are retracted and contour apparatus 50 is removed to facilitate further fabrication of the motor. Accordingly, brushes 22 are contoured while in their assembled locations and initial motor noise is reduced. After contouring a plurality of brushes, a dust may form on abrasive surface 32 that is removed by releasing compressed air proximate to abrasive surface 32 such that the dust is blown from abrasive surface 32. Alternatively, a vacuum (not shown) is utilized to remove the dust from abrasive surface 32.

FIG. 3 is a cross sectional view of a motor 70 including a plurality of contoured brushes 72 resiliently attached to a brush card 74 such that each brush 72 is biased toward a normal position. Each brush 72 can be retracted to a retracted position. When brushes 72 are in their normal positions, a contoured surface 76 of each brush 72 rotatably contacts a commutator 78 including a plurality of commutator bars 80. Brushes 72 were contoured using contour apparatus 10 (shown in FIG. 1). Each commutator bar 80 is connected to a rotor core 84 including a plurality of armature windings (not shown). Rotor core 84 and commutator 78 are attached to a rotor shaft 86 mounted in a plurality of endshields 88 including a first endshield 90. Rotor shaft 86 is rotatably supported by a plurality of bearings 92 held in place with a plurality of inner bearing caps 93. Brush card 74 is attached to first endshield 90. Each endshield 88 includes a rabbet 94 that attaches each endshield 88 to a housing 96 including a stator 98 mounted therein and including a bore 100 therethrough. Stator 98 includes a plurality of stator windings (not shown). Housing 96 further includes a first end 102 and a second end 104. In an alternative embodiment of motor 70, brush card 74 is attached to stator 98 rather than first endshield 90.

During fabrication of motor 70, brush card 74 including brushes 72 is attached to first endshield 90 and each brush 72 is retracted to a retracted position a first time. Top plate 20 (shown in FIG. 1) is positioned within rabbet 94 of first endshield 90 such that contour wheel 16 is substantially centered among brushes 72 and brushes 72 are released from the retracted positions. Since brushes 72 are biased toward their normal positions, brushes 72 contact contour wheel 16. Handle 12 is turned one-half turn in a first direction and one-half turn in a second direction. Since contour wheel 16 includes abrasive surface 32, brushes 72 wear-in to contour wheel 16. Brushes 72 are retracted a second time and contour wheel 16 is removed. Rotor shaft 86 including commutator 78 is positioned in motor 70 and brushes 72 are released from the retracted positions. Since brushes 72 are biased toward their normal positions, brushes 72 contact commutator 78. Furthermore, since commutator 78 is substantially sized equally in radius to contour wheel 16, brushes 72 are worn-in to commutator 78 before initially contacting commutator 78. After fabricating a plurality of motors, a dust may form on abrasive surface 32 that is removed by releasing compressed air proximate to abrasive surface 32 such that the dust is blown from abrasive surface 32. Alternatively, a vacuum (not shown) is utilized to remove the dust from abrasive surface 32.

During initial operation of motor 70, the stator windings are energized producing a plurality of stator poles and the armature windings are energized producing a plurality of rotor poles that oppose the fixed stator poles causing rotor shaft 86 to rotate. The commutator bars are arranged to alternate the current direction through the armature windings such that a torque is continuously provided. Since brushes 72 have been contoured to commutator 80 through the use of contour apparatus 10, brushes 72 are worn-in already and motor 70 generates less noise than a motor without contoured brushes.

While the invention has been described in terms of various specific embodiments, those skilled in the art will recognize that the invention can be practiced with modification within the spirit and scope of the claims.

What is claimed is:

1. A method of seating a motor brush to a commutator, said method comprising the steps of:
mounting a brush in a brush card;
contouring the brush; and
positioning the commutator such that the brush makes an initial contact with the commutator after the brush was contoured.

2. A method according to claim 1 wherein said step of contouring the brush further comprises the step of contouring the brush with a contour wheel.

3. A method according to claim 1 wherein said step of contouring the brush further comprises the step of contouring the brush with a contour wheel having a grit size less than about 320.

4. A method according to claim 1 wherein said step of mounting a brush in a brush card further comprises the step of mounting a brush in a brush card attached to at least one of an endshield and a stator.

5. A method according to claim 1 wherein said step of contouring the brush further comprises the steps of:
retracting the brush a first time;
positioning a contour wheel proximate to the brush;
releasing the retracted brush such that the brush contacts the contour wheel; and
rotating the contour wheel.

6. A method according to claim 5 wherein said step of rotating the contour wheel further comprises the steps of:
rotating the contour wheel in a first direction; and
rotating the contour wheel in a second direction.

7. A method according to claim 6 further comprising the steps of:
retracting the brush a second time;
positioning the contour wheel away from the brush;
positioning the commutator proximate to the brush; and
releasing the brush such that the brush makes an initial contact with the commutator.

8. A method according to claim 7 wherein said step of positioning the commutator further comprises the step of positioning the commutator having a radius substantially equal to a radius of the contour wheel.

9. A method of fabricating a motor, said method comprising the steps of:
mounting a brush card including a plurality of brushes to at least one of an endshield and a stator;
contouring at least one brush after the brush card is mounted; and
positioning a commutator such that the contoured brush makes an initial contact with the commutator after the brush was contoured.

10. A method according to claim 9 wherein said step of contouring at least one brush further comprises contouring at least one brush with a contour wheel.

11. A method according to claim 9 wherein said step of contouring at least one brush further includes contouring at least one brush with a contour wheel having a grit size less than about 320.

12. A method according to claim 9 wherein said step of contouring at least one brush comprises the steps of:
retracting at least one brush a first time;
positioning a contour wheel proximate the retracted brush;
releasing the retracted brush such that the released brush contacts the contour wheel; and
rotating the contour wheel.

13. A method according to claim 12 wherein said step of rotating the contour wheel comprises the steps of:
rotating the contour wheel in a first direction; and
rotating the contour wheel in a second direction.

14. A method according to claim 13 further comprising the steps of:
retracting the released brush a second time;
positioning the contour wheel away from the retracted brush;
positioning a commutator proximate the retracted brush; and
releasing the retracted brush such that the brush makes an initial contact with the commutator.

15. A method according to claim 14 wherein said step of positioning the commutator further comprises the step of positioning the commutator having a radius substantially equal to a radius of the contour wheel.

16. Apparatus for contouring a brush of a motor, said apparatus comprising:
a substantially circular contour wheel comprising an abrasive surface;
a shaft extending substantially perpendicular to said contour wheel; and
a top plate attached to said shaft opposite said contour wheel away from an end of said shaft such that said shaft extends through said top plate, said top plate can be engaged with at least one of an endshield and a housing for a stator, said top plate comprising at least one bearing rotatably supporting said shaft.

17. Apparatus according to claim 16 wherein said abrasive surface comprises a grit size of less than about 320.

18. Apparatus according to claim 16 wherein said substantially circular contour wheel has a radius substantially equal to a radius of a commutator for the motor.

19. Apparatus according to claim 16 further comprising a handle attached to said shaft end opposite said contour wheel.

20. Apparatus according to claim 16 wherein said top plate further comprises at least two bearings rotatably supporting said shaft.
